(19) United States
(12) Patent Application Publication
(10) Pub. No.: US 2026/0019204 A1
(43) Pub. Date: Jan. 15, 2026

(54) BASE STATION DEVICE, TERMINAL DEVICE, AND WIRELESS COMMUNICATION SYSTEM

(71) Applicant: Fujitsu Limited, Kawasaki-shi Kanagawa (JP)

(72) Inventors: Taewoo LEE, Edogawa (JP); Teppei OYAMA, Kawasaki (JP); Tsuyoshi SHIMOMURA, Yokohama (JP)

(73) Assignee: Fujitsu Limited, Kawasaki-shi Kanagawa (JP)

(21) Appl. No.: 19/294,499

(22) Filed: Aug. 8, 2025

Related U.S. Application Data
(63) Continuation of application No. PCT/JP2023/004415, filed on Feb. 9, 2023.

(51) Int. Cl. H04L 5/00; H04L 27/26

(52) U.S. Cl. CPC H04L 5/0044; H04L 27/2666

(57) ABSTRACT

A base station device in a wireless communication system supporting first communication in which uplink communication and downlink communication are performed with same timing by using different frequencies in a first slot in a carrier includes: a notifier that notifies a terminal device of first information regarding the first communication; and a communicator that performs the uplink communication with the terminal device in the first slot in accordance with the first information, wherein the first information includes information regarding an uplink resource of the uplink communication.

### CROSS-REFERENCE TO RELATED APPLICATION

This application is a continuation application of International Application Number PCT/JP2023/004415 filed on Feb. 9, 2023 and designated the U.S., the entire contents of which are incorporated herein by reference.

### FIELD

The present disclosure relates to a base station device, a terminal device, and a wireless communication system.

### BACKGROUND

Wireless communication systems need efficient use of radio resources. As one method for efficient use of radio resources, a technique called Sub-band Full Duplex (SBFD) has been contemplated in Third Generation Partnership Project (3GPP) (registered trademark).

The SBFD is a method in which a frequency resource in the same time resource of Time Division Duplex (TDD) cis able to be allocated to both the uplink and the downlink. The frequency resource may be a resource block. In the SBFD, the target slot is used as an uplink resource in one terminal device, and is used as a downlink resource in another terminal device. The base station device performs reception in the uplink resource and transmission in the downlink resource with the same timing in the target slot.

Techniques relating to the SBFD are described in the following related art literature.

### CITATION LIST

### Non-Patent Literature

Non-patent Literature 1: 3GPP TS 36.133 V17.7.0
Non-patent Literature 2: 3GPP TS 36.211 V17.2.0
Non-patent Literature 3: 3GPP TS 36.212 V17.1.0
Non-patent Literature 4: 3GPP TS 36.213 V17.3.0
Non-patent Literature 5: 3GPP TS 36.214 V17.0.0
Non-patent Literature 6: 3GPP TS 36.300 V17.2.0
Non-patent Literature 7: 3GPP TS 36.321 V17.2.0
Non-patent Literature 8: 3GPP TS 36.322 V17.0.0
Non-patent Literature 9: 3GPP TS 36.323 V17.1.0
Non-patent Literature 10: 3GPP TS 36.331 V17.2.0
Non-patent Literature 11: 3GPP TS 37.324 V17.0.0
Non-patent Literature 12: 3GPP TS 37.340 V17.2.0
Non-patent Literature 13: 3GPP TS 38.133 V17.7.0
Non-patent Literature 14: 3GPP TS 38.201 V17.0.0
Non-patent Literature 15: 3GPP TS 38.202 V17.2.0
Non-patent Literature 16: 3GPP TS 38.211 V17.3.0
Non-patent Literature 17: 3GPP TS 38.212 V17.3.0
Non-patent Literature 18: 3GPP TS 38.213 V17.3.0
Non-patent Literature 19: 3GPP TS 38.214 V17.3.0
Non-patent Literature 20: 3GPP TS 38.215 V17.2.0
Non-patent Literature 21: 3GPP TS 38.300 V17.2.0
Non-patent Literature 22: 3GPP TS 38.321 V17.2.0
Non-patent Literature 23: 3GPP TS 38.322 V17.1.0
Non-patent Literature 24: 3GPP TS 38.323 V17.2.0
Non-patent Literature 25: 3GPP TS 38.331 V17.2.0
Non-patent Literature 26: 3GPP TS 38.420 V17.2.0
Non-patent Literature 27: 3GPP TS 38.423 V17.2.0
Non-patent Literature 28: RP-222110
Non-patent Literature 29: R1-2212374

### SUMMARY

A base station device in a wireless communication system supporting first communication in which uplink communication and downlink communication are performed with same timing by using different frequencies in a first slot in a carrier, the base station device includes, a notifier that notifies a terminal device of first information regarding the first communication, and a communicator that performs the uplink communication with the terminal device in the first slot in accordance with the first information, wherein the first information includes information regarding an uplink resource of the uplink communication.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example of the configuration of a wireless communication system 10.

FIG. 2 is a diagram illustrating an example of the configuration of the base station device 200.

FIG. 3 is a diagram illustrating a configuration example of the terminal device 100.

FIGS. 4A to 4C are diagrams illustrating examples of variables in the first method.

FIGS. 5A to 5D are diagrams illustrating examples of variables in the second method.

FIGS. 6A to 6D are diagrams illustrating examples of variables in the third method.

FIGS. 7A to 7D are diagrams illustrating examples of variables in the fourth method.

FIGS. 8A to 8C are diagrams illustrating examples of variables in the fifth method.

FIGS. 9A to 9C are diagrams illustrating examples of variables in the sixth method.

FIGS. 10A to 10C are diagrams illustrating examples of variables in the seventh method.

FIG. 11 is a diagram illustrating an example of a specification in the second method.

FIG. 12 is a diagram illustrating an example of a specification in the third method.

FIG. 13 is a diagram illustrating an example of a specification in the fourth method.

FIG. 14 is a diagram illustrating an example of a specification in the fifth method.

FIG. 15 is a diagram illustrating an example of a specification in the sixth method.

### DESCRIPTION OF EMBODIMENTS

In the SBFD, a method of notifying and a method of determining the slots that constitute the SBFD are still under review and have not been determined. Accordingly, in a situation where a downlink slot is switched to an uplink slot in a first slot on a first frequency in the SBFD, for instance, the slot configuration and the symbol configuration within the switched slot have not been determined.

### First Embodiment

A first embodiment is now described.

### <Regarding Wireless Communication System 10>

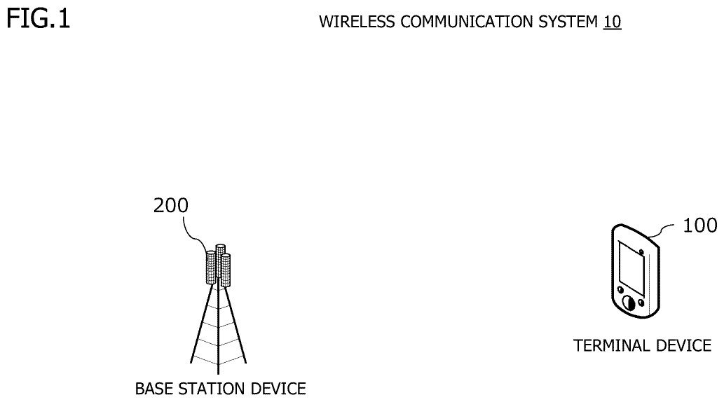

FIG. 1 is a diagram illustrating an example of the configuration of a wireless communication system 10. The wireless communication system 10 includes a base station device 200 and a terminal device 100. The wireless communication system 10 is a wireless communication system that supports SBFD.

The base station device 200 is a device that is wirelessly connected to the terminal device 100 and performs wireless communication, and may be an eNodeB or a gNodeB, for instance. The base station device 200 supports SBFD and supports communication generations, e.g., 5G and New Radio (NR). Also, the base station device 200 may be configured as a single device, or may be configured as multiple devices, e.g., a central unit (CU) and a distributed unit (DU).

The terminal device 100 is a communication device that is wirelessly connected to the base station device 200 and transmits and receives data, and may be a smartphone or a tablet terminal, for instance. The terminal device 100 supports SBFD.

In the wireless communication system 10, the base station device 200 notifies the terminal device 100 of radio resources supporting SBFD. The terminal device 100 uses the radio resources in accordance with instructions from the base station device 200.

### Configuration Example of Base Station Device 200

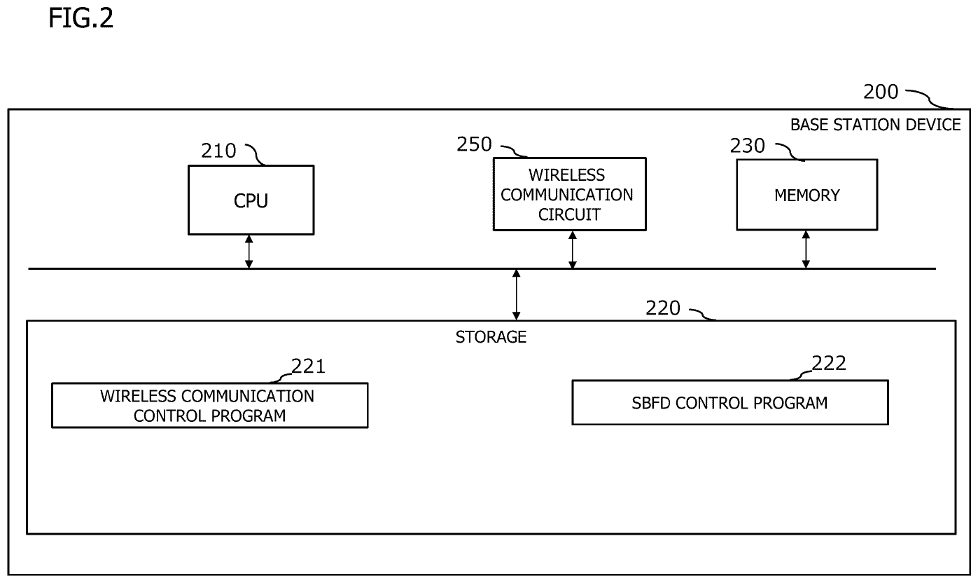

FIG. 2 is a diagram illustrating an example of the configuration of the base station device 200. The base station device 200 includes a central processing unit (CPU) 210, a storage 220, a memory 230, and a wireless communication circuit 250.

The storage 220 is an auxiliary storage device, e.g., a flash memory, a hard disk drive (HDD), or a solid-state drive (SSD), that stores programs and data. The storage 220 stores a wireless communication control program 221 and an SBFD control program 222.

The memory 230 is an area into which the programs stored in the storage 220 are loaded. The memory 230 may also be used as an area for programs to store data.

The wireless communication circuit 250 is a device that performs wireless communication with the terminal device 100. The base station device 200 transmits and receives signals (messages) to and from the terminal device 100 via the wireless communication circuit 250.

The CPU 210 is a processor that loads a program stored in the storage 220 into the memory 230, executes the loaded program, constructs each unit, and implements each processing.

The CPU 210 executes a wireless communication control program to establish a communication unit and perform wireless communication control processing. The wireless communication control processing is processing of establishing a wireless connection with the terminal device 100 and transmitting and receiving signals (messages) via the wireless connection. The base station device 200 controls wireless communication in wireless communication control processing.

The CPU 210 executes the SBFD control program to establish a notification unit and perform SBFD control processing. The SBFD control processing is processing of setting and notifying the slot configuration associated with the execution of SBFD. The base station device 200 notifies and instructs the terminal device 100 of the slot and symbol configuration in the SBFD control processing.

### Configuration Example of Terminal Device 100

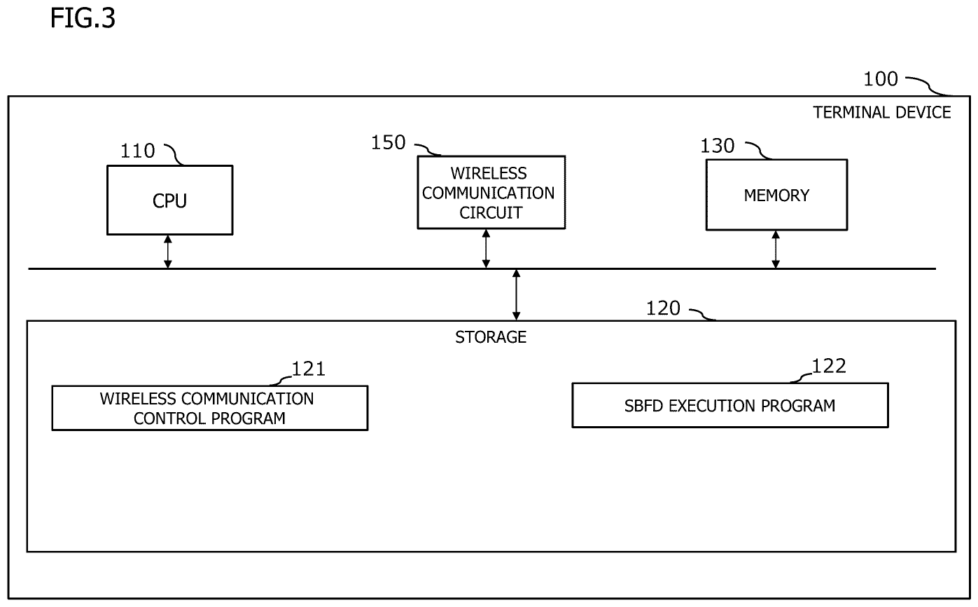

FIG. 3 is a diagram illustrating a configuration example of the terminal device 100. The terminal device 100 includes a CPU 110, a storage 120, a memory 130, and a wireless communication circuit 150.

The storage 120 is an auxiliary storage device, e.g., a flash memory, HDD, or SSD, that stores programs and data. The storage 120 stores a wireless communication program 121 and an SBFD execution program 122.

The memory 130 is an area into which the programs stored in the storage 120 are loaded. The memory 130 may also be used as an area for programs to store data.

The wireless communication circuit 150 is a device that performs wireless communication with the base station device 200. The terminal device 100 transmits and receives signals (messages) to and from the base station device 200 via the wireless communication circuit 150.

The CPU 110 is a processor that loads a program stored in the storage 120 into the memory 130, executes the loaded program, constructs each unit, and implements each processing.

The CPU 110 executes the wireless communication program 121 to establish a terminal communication unit and perform wireless communication processing. The wireless communication processing is processing of wirelessly connecting to the base station device 200 and performing communication.

The CPU 110 executes the SBFD execution program 122 to establish a reception unit and perform SBFD execution processing. The SBFD execution processing is processing of executing SBFD in accordance with an instruction from the base station device 200. In the SBFD execution processing, the terminal device 100 receives information regarding the configuration of SBFD slots and symbols. In the SBFD execution processing, the terminal device 100 executes SBFD in accordance with an instruction from the base station device 200.

For normal CP, one slot may consist of 14 symbols. For extended CP, one slot may consist of 12 symbols. In this embodiment, unless otherwise specified, the description will be given assuming normal CP is applied. However, the same advantageous effects are able to be elicited with extended CP, with the number of symbols in one slot changed to 12.

An uplink may be a link through which the terminal device 100 transmits data to the base station device 200. A downlink may be a link through which the base station device 200 transmits data to the terminal device 100. Uplink communication may be the transmission of data by the terminal device 100 using an uplink resource and the reception of the data by the base station device 200. Downlink communication may be the transmission of data by the base station device 200 using a downlink resource and the reception of the data by the terminal device 100.

### <SBFD>

An example of SBFD is now described. Note that the following description is an example of SBFD, and the methods of allocating and notifying uplink and/or downlink radio resources are not limited to the following example. Furthermore, the present disclosure is applicable to communication methods other than SBFD in which one unit of radio resource, e.g., the same timing or the same frequency, is used for both the uplink and/or the downlink.

In SBFD, the base station device 200 notifies the terminal device 100 of information regarding SBFD (hereinafter, may be referred to as SBFD information). The notification may be performed using an RRC message, for instance. For instance, SBFD information is composed of multiple variables. SBFD notification methods of different variable names and usage are individually described below.

In the following figures, U (Uplink) represents uplink resources, D (Downlink) represents downlink resources, S (Special) represents special resources, and F (Flexible) represents flexible resources. Each resource represents a slot or a symbol. Also, a special resource is a resource in which uplink and downlink resources are mixed in units of symbols. A flexible resource may be a resource that is used as any of an uplink resource, a downlink resource, or a special resource, for instance. A special resource may be the same as a flexible resource.

Hereinafter, a downlink resource slot may be referred to as a D slot, an uplink resource slot as a U slot, a special resource slot as an S slot, and a flexible resource slot as an F slot. Furthermore, a downlink resource symbol may be referred to as a D symbol, an uplink resource symbol as a U symbol, and a flexible resource symbol as an F symbol.

Also, a U slot allocated in SBFD may be referred to as a U slot of SBFD. Also, a U symbol allocated in SBFD may be referred to as a U symbol of SBFD. Also, among the resource blocks on the U slots and U symbols allocated in SBFD, the resource blocks used for the uplink may be referred to as an uplink subband. Also, a U slot of SBFD may be set to a part or all of the frequency resources included in Active Bandwidth Part (BWP).

### <1. First Method>

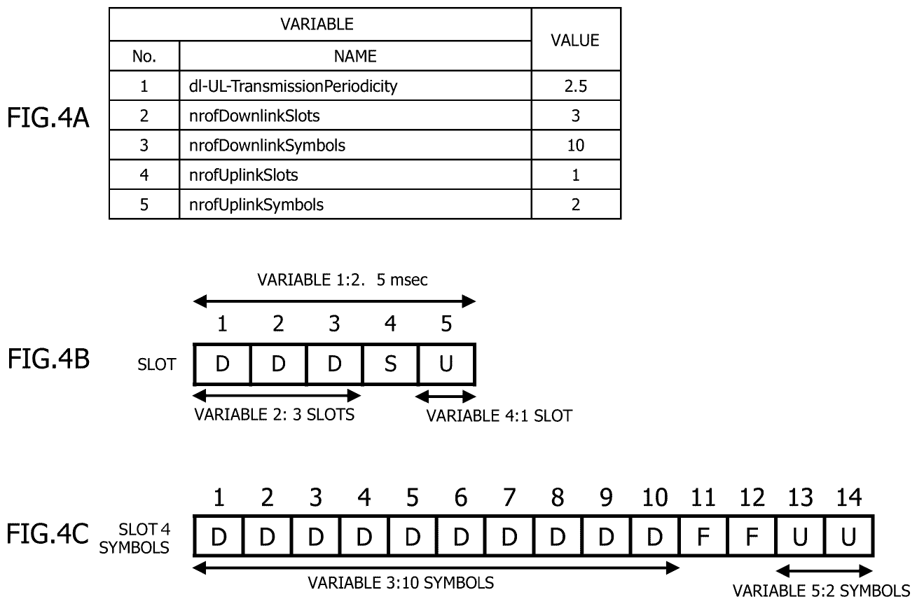

FIG. 4 is a diagram illustrating an example of variables in the first method. In the first method, the base station device 200 sets values to variables 1 to 5 in FIG. 4 and notifies the terminal device 100 of the values. The variables represent, for instance, the positions (timing) of U slots and U symbols, or G slots and G symbols. By receiving these variables, the terminal device 100 is able to identify the positions (timing) of U slots and U symbols, or G slots and G symbols.

FIG. 4A is a diagram illustrating an example of variables and setting values. FIG. 4B is a diagram illustrating an example of a slot configuration in a situation where the setting values in FIG. 4A are used. FIG. 4C is a diagram illustrating an example of a symbol configuration in a situation where the setting values in FIG. 4A are used.

Variable 1 is dl-UL-TransmissionPeriodicity and represents the slot period. For instance, when variable 1 is 2.5, five slots of 2.5 msec are set as one period as illustrated in FIG. 4B. Variable 1 may be in units of milliseconds (msec). A millisecond may be one thousandth of a second.

Variable 2 is nrofDownlinkSlots and represents the number of D slots from the beginning of the period. For instance, when variable 2 is set to 3, the first three slots (slots 1 to 3) are D slots as illustrated in FIG. 4B.

Variable 4 is nrofUplinkSlots and represents the number of U slots from the end of the period. For instance, when variable 4 is set to 1, the last slot (slot 5) is a U slot as illustrated in FIG. 4B.

Variables 1, 2, and 4 determine the slot configuration for each period. A slot that is not set as a D slot or a U slot (slot 4 in FIG. 4B) is an S slot or an F slot. In this case, slot 4 may be an S slot, for instance.

Variable 3 is nrofDownlinkSymbols and represents the number of D symbols from the symbol following the last symbol of the D slots. In FIG. 4B, since the last symbol of the D slots is the last symbol of slot 3, the following symbol is the first symbol of slot 4. For instance, when variable 3 is set to 10, the first ten symbols (symbols 1 to 10) of slot 4 are D symbols as illustrated in FIG. 4C.

Variable 5 is nrofUplinkSymbols and represents the number of U symbols from the symbol preceding the first symbol of the U slot. In FIG. 4B, the first symbol of the U slot is the first symbol of slot 5, so the preceding symbol is the last symbol of slot 4. For instance, when variable 5 is set to 2, the last two symbols in slot 4 (symbols 13 and 14) are U symbols as illustrated in FIG. 4C.

Variables 3 and 5 determine the symbol configuration of the S slot. A slot that is not set to D symbols or U symbols (slot 4 in FIG. 4B) is set to F symbols. In this case, symbols 11 and 12 in slot 4 are F symbols.

In the first method, with the settings as illustrated in FIG. 4, the terminal device 100 switches between uplink and downlink transmission and reception between symbol 10 and symbol 13 in slot 4 (symbols 11 and 12). In this case, the terminal device 100 is able to switch in time with an F symbol, for instance. However, since an F symbol may be used as a U symbol or a D symbol, the switching time of the terminal device 100 may not be secured. Also, with the first method, it is not possible to notify the setting of SBFD slots (symbols).

In this respect, in the following methods, the setting of time resources used for SBFD is described. The time resource setting may include, for instance, information regarding an interval when switching from a downlink symbol to an uplink symbol, e.g., a guard time (Guard Period or RF turn-around time). The time resource may be a slot or a symbol. Furthermore, the guard time may be configured by a flexible symbol, for instance.

### <2. Second Method>

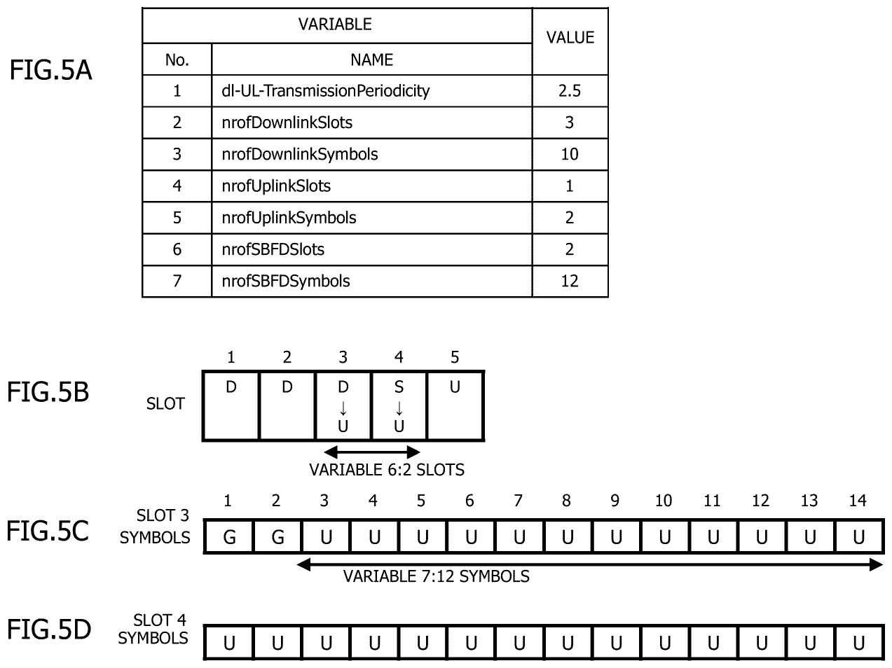

FIG. 5 is a diagram illustrating an example of variables in the second method. In the second method, the base station device 200 sets values to variables 1 to 7 in FIG. 5 and notifies the terminal device 100 of the values. FIG. 5A is a diagram illustrating an example of variables and setting values. FIG. 5B is a diagram illustrating an example of a slot configuration in a situation where the setting values in FIG. 5A are used. FIGS. 5C and 5D are diagrams illustrating examples of symbol configurations in a situation where the setting values in FIG. 5A are used. Slots 3 and 4 in FIG. 5B are examples of first slots. Variables 2 and 3 are examples of information regarding downlink resources. Also, variables 4, 5, 6, and 7 are examples of information regarding uplink resources. Also, variables 6 and 7 may be described as configuration information of SBFD slots. Furthermore, variables 6 and 7 are also able to be described as information regarding uplink resources in SBFD slots. In the following figures, G (Guard) represents guard time. Also, when the guard time is in units of slots, it may be referred to as guard slot (G slot). Also, when the guard time is in units of symbols, it may be referred to as guard symbol (G symbol). Also, the G slot is a slot in which neither uplink nor downlink signals are transmitted or received. Furthermore, the G symbol is a symbol in which neither uplink nor downlink signals are transmitted or received. The G symbol may also be described as flexible symbol. In short, the G symbol may be any symbol that is different from the uplink symbol and the downlink symbol.

Variables 1 to 5 are the same as in the first method.

Variable 6 is nrofSBFDSlots and represents the number of SBFD slots from the slot including the symbol before the first U symbol in the first U slot. When the slot period does not include a U slot, variable 6 represents the number of SBFD slots from the last slot of the slot period. For instance, when variable 6 is set to 2, as illustrated in FIG. 5B, the two slots (slots 3 and 4) before the first U symbol (first symbol of slot 5) are U slots of SBFD.

Variable 7 is nrofSBFDSymbols and represents the number of U symbols of SBFD in the first U slot of SBFD. The U symbols of SBFD of variable 7 are set in sequence from the last symbol of the first U slot of SBFD. Also, when the slot period does not include a U slot of SBFD, the U symbols of variable 7 may be set in sequence from the last symbol of the slot period. Also, when the slot period does not include a U slot of SBFD, the terminal device 100 does not need to expect to receive variable 7. For instance, when variable 7 is set to 12, 12 symbols (symbols 3 to 14) from the last symbol of slot 3, which is the first U slot of SBFD, are U symbols of SBFD as illustrated in FIG. 5C. Although slot 4 is a U slot of SBFD, it is not the first U slot of SBFD. Thus, slot 4 is not affected by variable 7, and all symbols are U symbols of SBFD as illustrated in FIG. 5D.

Variable 7 sets the U symbols of SBFD. In the U slots of SBFD, symbols other than those that are set as U symbols of SBFD are set as G symbols (symbols 1 and 2 in FIG. 5C).

In the second method, it is possible to configure the symbols in SBFD slots in SBFD by setting appropriate values to variables 6 and 7. For instance, setting appropriate values to variables 6 and 7 is able to set the guard time appropriately.

### <3. Third Method>

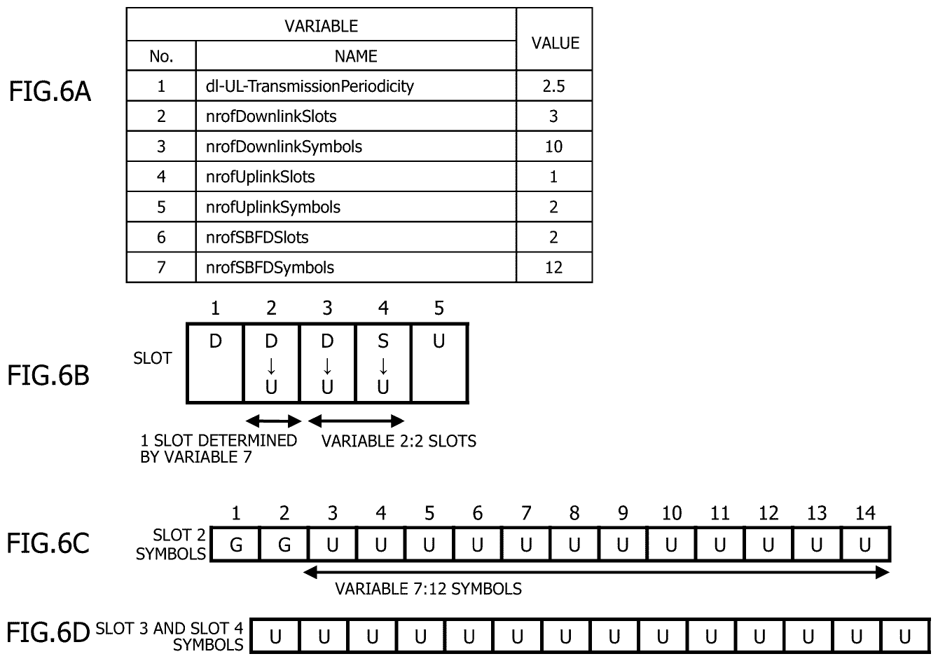

FIG. 6 is a diagram illustrating an example of variables in the third method. In the third method, the base station device 200 sets values to variables 1 to 7 in FIG. 6 and notifies the terminal device 100 of the values. FIG. 6A is a diagram illustrating an example of variables and setting values. FIG. 6B is a diagram illustrating an example of a slot configuration in a situation where the setting values in FIG. 6A are used. FIGS. 6C and 6D are diagrams illustrating examples of symbol configurations in a situation where the setting values in FIG. 6A are used. Slots 2, 3, and 4 in FIG. 6B are examples of first slots. Variables 2 and 3 are examples of information regarding downlink resources. Also, variables 4, 5, 6, and 7 are examples of information regarding uplink resources. Also, variables 6 and 7 may be described as configuration information of SBFD slots. Furthermore, variables 6 and 7 are also able to be described as information regarding uplink resources in SBFD slots.

Variables 1 to 5 are the same as in the first method.

Variable 6 is nrofSBFDSlots and represents the number of SBFD slots from the slot including the symbol before the first U symbol in the first U slot. When the slot period does not include a U slot, variable 6 represents the number of SBFD slots from the last slot of the slot period. For instance, when variable 6 is set to 2, as illustrated in FIG. 6B, the two slots (slots 3 and 4) before the first U symbol (first symbol of slot 5) are U slots of SBFD.

Variable 7 is nrofSBFDSymbols and represents the number of U symbols of SBFD from the symbol before the first symbol of the first U slot of SBFD. Also, when the slot period does not include a U slot of SBFD, the U symbols of variable 7 may be set in sequence from the last symbol of the slot period. Also, when the slot period does not include a U slot of SBFD, the terminal device 100 does not need to expect to receive variable 7. For instance, when variable 7 is set to 12, U symbols of SBFD are set to slot 2, which includes the symbol before the first symbol of the first U slot of SBFD (the first symbol of slot 3), as illustrated in FIG. 6B. Since U symbols of SBFD are set in slot 2, FIG. 6B indicates slot 2 as a U slot. Also, in slot 2, as illustrated in FIG. 6C, the last 12 symbols (symbols 3 to 14) are U symbols of SBFD. Slots 3 and 4 are U slots of SBFD, and all symbols are U symbols of SBFD as illustrated in FIG. 6D.

Variable 7 sets U symbols of SBFD. In the U slots of SBFD, symbols other than those that are set as U symbols of SBFD are set as G symbols (symbols 1 and 2 in FIG. 6C).

In the third method, the symbols in SBFD slots in SBFD are able to be configured by setting appropriate values to variables 6 and 7. For instance, setting appropriate values to variables 6 and 7 is able to set the guard time appropriately.

### <4. Fourth Method>

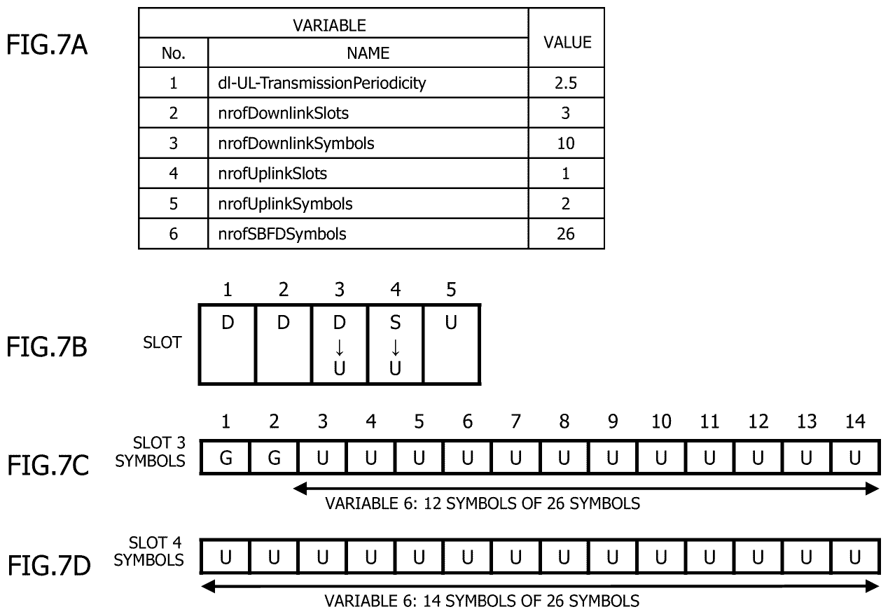

FIG. 7 is a diagram illustrating an example of variables in the fourth method. In the fourth method, the base station device 200 sets values to variables 1 to 6 in FIG. 7 and notifies the terminal device 100 of the values. FIG. 7A is a diagram illustrating an example of variables and setting values. FIG. 7B is a diagram illustrating an example of a slot configuration in a situation where the setting values in FIG. 7A are used. FIGS. 7C and 7D are diagrams illustrating examples of symbol configurations in a situation where the setting values in FIG. 7A are used. Slots 3 and 4 in FIG. 7B are examples of first slots. Variables 2 and 3 are examples of information regarding downlink resources. Also, variables 4, 5, and 6 are examples of information regarding uplink resources. Also, variable 6 may be described as configuration information of the SBFD slots. Furthermore, variable 6 are also be able to be described as information regarding uplink resources in the SBFD slots.

Variables 1 to 5 are the same as in the first method.

Variable 6 is nrofSBFDSymbols and represents the number of SBFD symbols from the symbol before the first U symbol. Also, when the slot period does not include a U symbol, the U symbols of variable 6 may be set in sequence from the last symbol of the slot period. Also, when the slot period does not include a U symbol, the terminal device 100 does not need to expect to receive variable 6. For instance, when variable 6 is set to 26, the 26 symbols before the first U symbol (first symbol of slot 5) are U symbols of SBFD. Since there are 26 symbols, slots 3 and 4 are U slots of SBFD as illustrated in FIG. 7B. Also, all symbols in slot 4 are U symbols of SBFD as illustrated in FIG. 7D, and the last 12 symbols of slot 3 (symbols 3 to 14) are U symbols of SBFD as illustrated in FIG. 7C.

Variable 6 sets the U symbols of SBFD. In the U slots of SBFD, symbols other than those that are set as U symbols are set as G symbols (symbols 1 and 2 in FIG. 7C).

In the fourth method, the symbols in SBFD slots in SBFD are able to be configured by setting appropriate values to variable 6. For instance, setting appropriate values to variable 6 is able to set the guard time appropriately.

### <5. Fifth Method>

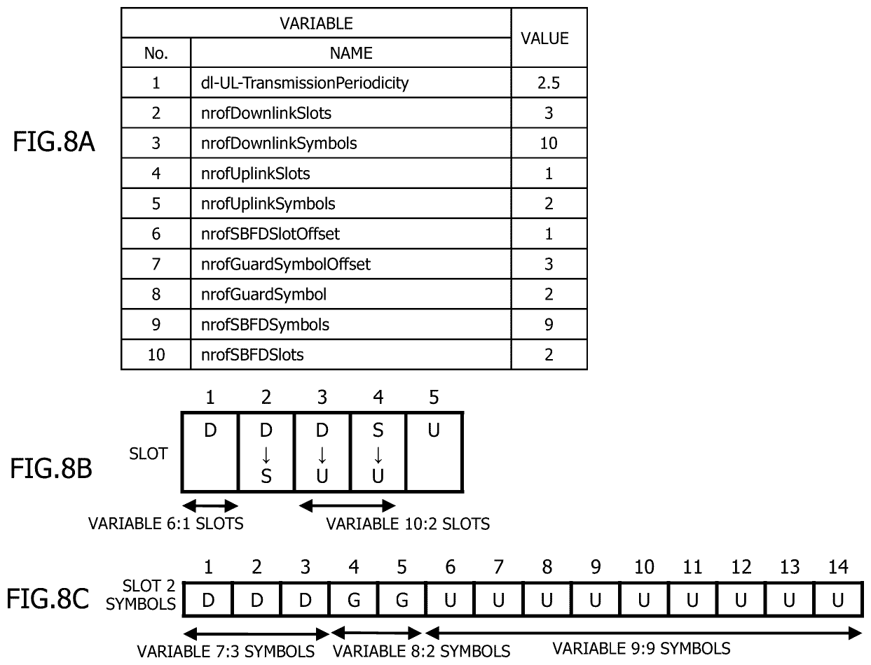

FIG. 8 is a diagram illustrating an example of variables in the fifth method. In the fifth method, the base station device 200 sets values to variables 1 to 10 in FIG. 8 and notifies the terminal device 100 of the values. FIG. 8A is a diagram illustrating an example of variables and setting values. FIG. 8B is a diagram illustrating an example of a slot configuration in a situation where the setting values in FIG. 8A are used. FIG. 8C is a diagram illustrating an example of a symbol configuration in a situation where the setting values in FIG. 8A are used. Slots 2, 3, and 4 in FIG. 8B are examples of the first slots. Variables 2 and 3 are examples of information regarding downlink resources. Also, variables 4, 5, 9, and 10 are examples of information regarding uplink resources. Also, variables 6 to 10 may be described as configuration information of the SBFD slots. Furthermore, variables 9 and 10 are also be able to be described as information regarding uplink resources in the SBFD slots. Also, variables 7 and 8 are also able to be described as information regarding the guard time.

Variables 1 to 5 are the same as in the first method.

Variable 6 is nrofGuardSlotOffset and represents the number of offset slots for setting the U slots of SBFD from the first slot of the period. For instance, when variable 6 is set to 1, as illustrated in FIG. 8B, one slot (slot 1) from the first slot is offset, and a U slot of SBFD is not set.

Variable 10 is nrofSBFDSlots and represents the number of SBFD slots from the slot including the symbol before the first U symbol in the first U slot. When the slot period does not include a U slot, variable 10 represents the number of SBFD slots from the last slot of the slot period. For instance, when variable 10 is set to 2, as illustrated in FIG. 8B, the two slots (slots 3 and 4) from the first U slot (slot 5) are U slots of SBFD.

Variable 7 is nrofGuardSymbolOffset and represents the number of offset symbols for setting G symbols from the first symbol in the slot before the first U slot of SBFD. For instance, when variable 7 is set to 3, as illustrated in FIG. 8C, three symbols (symbols 1 to 3) from the first symbol of the slot (slot 2) before the first SBFD slot (slot 3) are treated as offset and remain as D symbols. Slot 2, in which U symbols and D symbols of SBFD are mixed, is indicated as S slot in FIG. 8B.

Variable 8 is nrofGuardSymbol and represents the number of G symbols to be set from the offset of variable 7. For instance, when variable 8 is set to 2, the two symbols (symbols 4 and 5) after the three offset symbols are G symbols as illustrated in FIG. 8C.

Variable 9 is nrofSBFDSymbols and represents the number of U symbols of SBFD to be set before the G symbol or the first symbol of the U slot of SBFD. For instance, when variable 9 is set to 9, the nine symbols (symbols 6 to 14) following the last G symbol (symbol 5) are U symbols of SBFD as illustrated in FIG. 8C.

When the value of one of variable 8 and 9 is determined by determining the value of the other, it is sufficient to notify one of the values. Also, in a slot including a G symbol, the total number of D symbols, G symbols, and U symbols of SBFD may be 14.

In the fifth method, the symbols in SBFD slots in SBFD are able to be configured by setting appropriate values to variables 6 to 10. For instance, setting appropriate values to variables 6 to 10 is able to set the guard time appropriately.

### <6. Sixth Method>

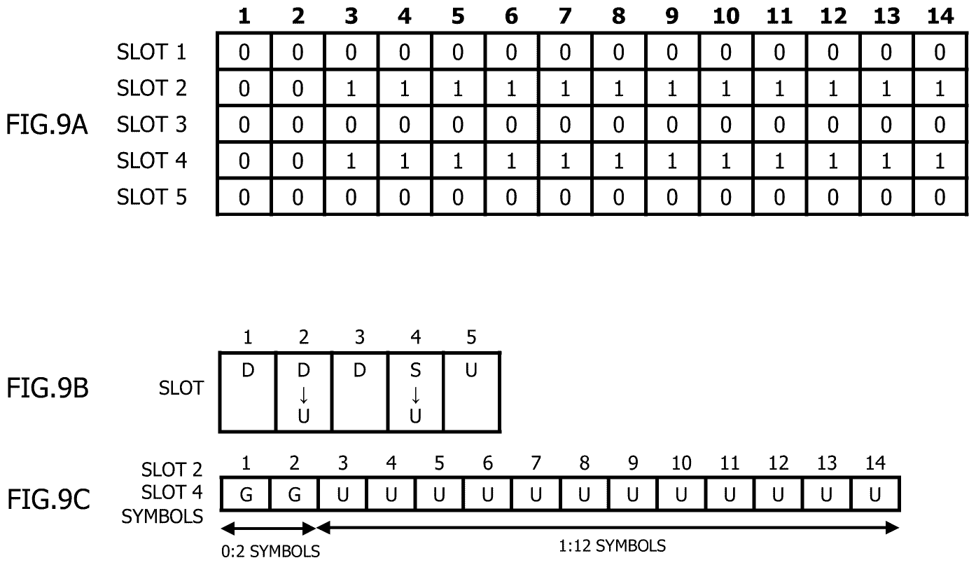

FIG. 9 is a diagram illustrating an example of variables in the sixth method. In the sixth method, the base station device 200 notifies the terminal device 100 of a bitmap. FIG. 9A is a diagram illustrating an example of a bitmap. FIG. 9B is a diagram illustrating an example of a slot configuration in a situation where the setting values in FIG. 9A are used. FIG. 9C is a diagram illustrating an example of a symbol configuration in a situation where the setting values in FIG. 9A are used. The bitmap may also be described as configuration information of SBFD slot. The bitmap is an example of information regarding uplink resources.

The example of FIG. 9 is an example in which the bitmap in FIG. 9A is applied after (or simultaneously with) the setting of variables 1 to 5 in the first method of FIG. 4.

The bitmap of FIG. 9A indicates the positions of U symbols of SBFD, and needs bits in a number obtained by multiplying the number of slots in one period by the number of symbols in one slot. In the case of FIG. 9A, 5 slots×14 symbols results in 70 bits. The bitmap corresponds to each slot and each symbol, starting from the most significant bit. For instance, the 1st bit to the 14th bit correspond to symbols 1 to 14 in slot 1.

When the bit is 0, it represents that it is not a U symbol of SBFD. When the bit is 1, it represents that it is a U symbol of SBFD. That is, according to FIG. 9A, symbols 3 to 14 in slots 2 and 4 are U symbols of SBFD.

According to this bitmap, slots 2 and 4 including U symbols of SBFD are U slots of SBFD as illustrated in FIG. 9B.

In slots 2 and 4, the bits of the most significant two symbols (symbols 1 and 2) are 0. These two symbols are D symbols before SBFD is applied. However, in the fifth method, symbols other than the U symbol in the slot including the U symbol of SBFD are set as G symbols. As a result, in slots 2 and 4, the most significant two symbols (symbols 1 and 2) are G symbols as illustrated in FIG. 9C. The SBFD application may be setting SBFD slots or SBFD symbols.

In the sixth method, the symbols in SBFD slots in SBFD are able to be configured by setting appropriate values to the bitmap. For instance, setting appropriate values to the bitmap is able to set the guard time appropriately.

### <7. Seventh Method>

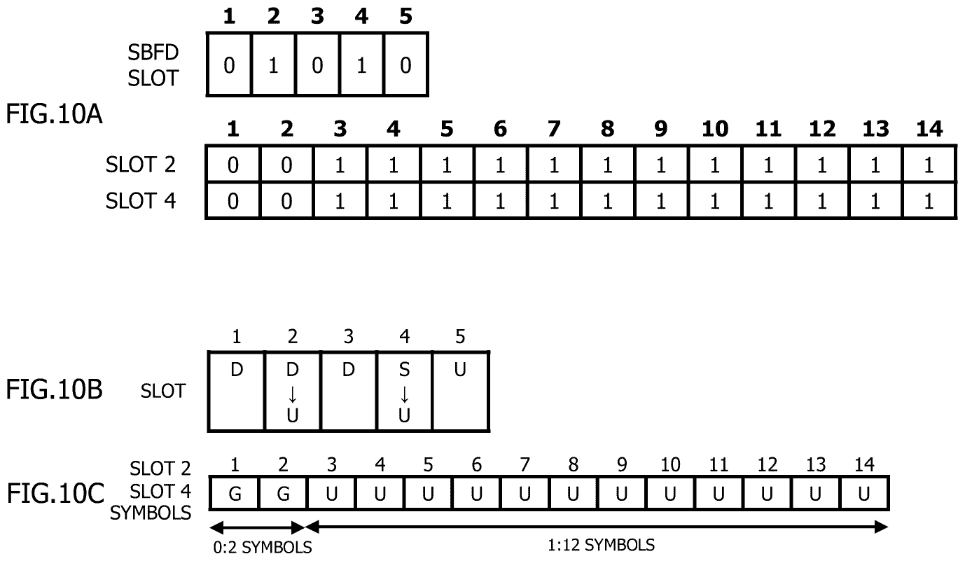

FIG. 10 is a diagram illustrating an example of variables in the seventh method. The base station device 200 notifies the terminal device 100 of a bitmap. FIG. 10A is a diagram illustrating an example of a bitmap. FIG. 10B is a diagram illustrating an example of a slot configuration in a situation where the setting values in FIG. 10A are used. FIG. 10C is a diagram illustrating an example of a symbol configuration in a situation where the setting values in FIG. 10A are used. The bitmap for SBFD slot illustrated in FIG. 10A may be described as configuration information of SBFD slot. The bitmap is an example of information regarding uplink resources.

The example in FIG. 10 is an example in which the bitmap in FIG. 10A is applied after (or simultaneously with) the setting of variables 1 to 5 in the first method in FIG. 4.

The bitmap in FIG. 10A is a bitmap indicating the slot configuration of SBFD and the positions of U symbols of SBFD. For instance, in the bitmap of the slot configuration, the slots indicated by 1 (slots 2 and 4) are U slots of SBFD.

Then, the bitmap for slots 2 and 4 determines the positions of the U symbols of SBFD in each slot. G symbols are determined in the same manner as in the sixth method.

The slot configuration and symbol configuration are the same as those in FIG. 9 for the sixth method.

In the seventh method, the symbols in SBFD slots in SBFD are able to be configured by setting appropriate values in a bitmap. For instance, setting appropriate values to the bitmap is able to set the guard time appropriately.

In all the methods, an SBFD slot may be a slot in which a U slot of SBFD is set. Additionally, in all the methods, the uplink subband configured in U slots of SBFD may use a part or all of the frequency resources of each slot.

As described above, in the first embodiment, to perform uplink communication and downlink communication with the same timing in a carrier using different frequencies in the same slot, the base station transmits information regarding the uplink resources for the uplink communication in this slot to a first terminal. This allows the base station to perform uplink communication with the first terminal and downlink communication with a second terminal in a first slot, for instance. Furthermore, the frequency resources used by the first terminal may differ from the frequency resources used by the second terminal. In other words, the base station is able to set SBFD.

### Second Embodiment

A second embodiment is now described. A U symbol of SBFD may be set on a D symbol or an F symbol, for instance. For instance, as for a situation where a U symbol of SBFD is set on a D symbol, no decision has yet been made regarding how the terminal device 100 handles the reception of downlink messages at that timing. In the following, the U symbol of SBFD is described as an example, but the same advantageous effects are able to be obtained even when it is replaced with the U slot of SBFD.

In this respect, it is assumed that, in the wireless communication system 10, the terminal device 100 is able to receive downlink messages when the reception of downlink messages overlaps the timing of the U symbol of SBFD.

For instance, when the PDSCH scheduling and the U symbol of SBFD overlap, the terminal device 100 receives the PDSCH on the U symbol.

Furthermore, for instance, when the PDCCH Monitoring symbol and the U symbol of SBFD overlap, the terminal device 100 performs PDCCH Monitoring on the U symbol of SBFD.

In this manner, when the terminal device 100 is enabled to receive a downlink message on the U symbol of SBFD, a switching time (G symbol) between transmission and reception may be needed. Thus, when a downlink message is received on the U symbol of SBFD, the Nth symbol (N is an integer) after receiving the downlink message is set to a G symbol, for instance. This allows the terminal device 100 to secure the switching time between transmission and reception. The N may be a constant. The base station device 200 may notify the terminal device 100 of N. The terminal device 100 does not need to transmit an uplink message on those N symbols. The uplink message may be a PUSCH. The uplink message may be a PUCCH. The uplink message may be an SRS. The terminal device 100 does not need to expect to receive a downlink message on the N symbol. The downlink message may be a PDCCH. The downlink message may be a PDSCH. The downlink message may be a CSR-RS. The downlink message may be an SS/PBCH block.

Also, the terminal device 100 may receive a downlink message only when there is no data to transmit in the U symbol of SBFD, for instance. The terminal device 100 may prioritize the transmission of uplink data.

Also, the terminal device 100 may determine, for each type of downlink message, whether to receive a downlink message on the U symbol of SBFD. For instance, the terminal device 100 may perform control such that the terminal device 100 receives the downlink message when the downlink message is carried on the PDCCH, but does not receive the downlink message when it is carried on the PDSCH. The PDSCH and PDCCH may be reversed. Moreover, the type of the downlink message may be determined according to the data length, the priority of the data, the allowable delay time, and the like.

Furthermore, when a downlink message is generated, the base station device 200 may change SBFD setting and notify the terminal device 100. For instance, when the base station device 200 wants the terminal device 100 to receive a downlink message on a U symbol of SBFD, the base station device 200 may change this U symbol of SBFD to a D symbol (returning to the setting before the U symbols of SBFD are allocated) or change the slot or symbol configuration. Also, the base station device 200 may change SBFD setting for each terminal device and notify each terminal device separately.

### Other Embodiments

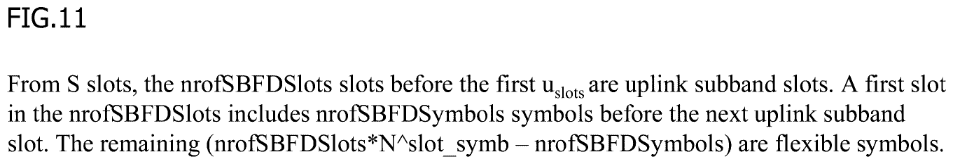

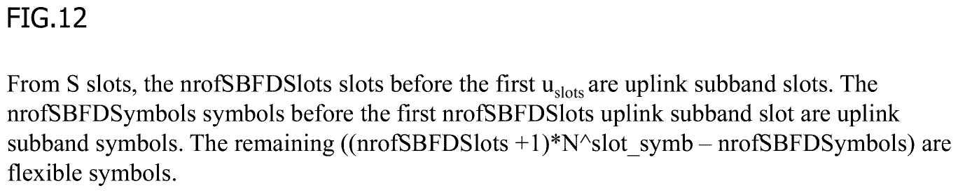

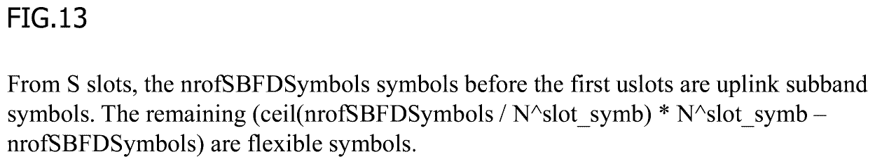

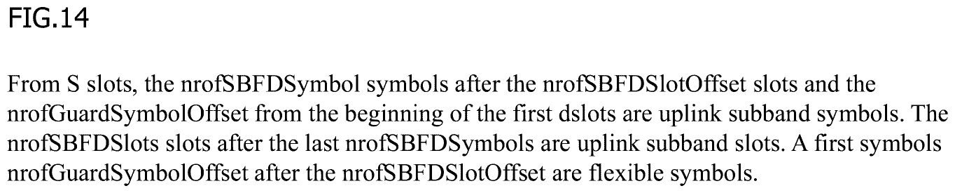

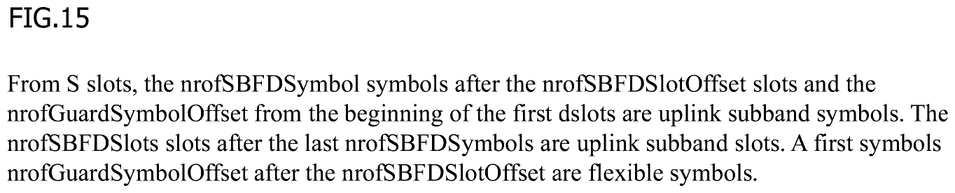

Descriptions in the 3GPP specifications in the embodiment are now described. FIG. 11 is a diagram illustrating an example of a specification in the second method. FIG. 12 is a diagram illustrating an example of a specification in the third method. FIG. 13 is a diagram illustrating an example of a specification in the fourth method. FIG. 14 is a diagram illustrating an example of a specification in the fifth method. FIG. 15 is a diagram illustrating an example of a specification in the sixth method.

The base station device 200 may use each of the methods depending on the slot or symbol configuration, for instance. The base station device 200 may support two or more methods, for instance. In this case, the base station device 200 notifies the terminal device 100 of the method to be used. Also, the terminal device 100 may notify the base station device 200 of the method that the terminal device is able to support.

Also, the names of variables, symbols, slots, and messages are merely examples, and different names may be used. Furthermore, the description of the specifications is merely an example, and the wording, specification title, paragraph, and the like may be different.

One disclosure enables setting of configuration of the SBFD.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A base station device in a wireless communication system supporting first communication in which uplink communication and downlink communication are performed with same timing by using different frequencies in a first slot in a carrier, the base station device comprising:
a notifier that notifies a terminal device of first information regarding the first communication; and
a communicator that performs the uplink communication with the terminal device in the first slot in accordance with the first information, wherein
the first information includes information regarding an uplink resource of the uplink communication.

2. The base station device according to claim 1, wherein the first information includes information representing a number of symbols for performing uplink communication in the first slot.

3. The base station device according to claim 1, wherein the first information includes information regarding a resource that is used neither as the uplink resource nor as a downlink resource.

4. The base station device according to claim 3, wherein the first information includes information regarding timing of a guard symbol that is a symbol used neither as the uplink resource nor as the downlink resource.

5. The base station device according to claim 1, wherein
the first information includes information regarding timing of an uplink symbol used as the uplink resource in the first communication, and
the terminal device uses neither as an uplink resource nor as a downlink resource a symbol other than the uplink symbol in a slot including the uplink symbol and a downlink symbol used as a downlink resource.

6. A terminal device in a wireless communication system that includes a terminal station device supporting first communication in which uplink communication and downlink communication are performed with same timing by using different frequencies in a first slot in a carrier, the terminal device comprising:
a receiver that receives from the base station device first information regarding the first communication; and
a terminal communicator that performs the uplink communication with the base station device in the first slot in accordance with the first information, wherein
the first information includes information regarding an uplink resource of the uplink communication.

7. A wireless communication system supporting first communication in which uplink communication and downlink communication are performed with same timing by using different frequencies in a first slot in a carrier, wherein
a base station device notifies a terminal device of first information regarding the first communication,
the terminal device receives the first information,
the base station device and the terminal device perform the uplink communication in the first slot in accordance with the first information, and
the first information includes information regarding an uplink resource of the uplink communication.
